(19) United States
(12) Patent Application Publication
(10) Pub. No.: US 2011/0127198 A1
(43) Pub. Date: Jun. 2, 2011

(54) OIL SAND SLURRY SOLIDS REDUCTION TO ENHANCE EXTRACTION PERFORMANCE FOR PROBLEM ORES

(75) Inventors: ROBERT SIY, Edmonton (CA); GEORGE CYMERMAN, Edmonton (CA); JUN LONG, Edmonton (CA); JESSICA VANDENBERGHE, Edmonton (CA)

(73) Assignee: SYNCRUDE CANADA LTD. in trust for the owners of the Syncrude Project, Fort McMurray (CA)

(21) Appl. No.: 12/938,206

(22) Filed: Nov. 2, 2010

Related U.S. Application Data
(60) Provisional application No. 61/257,552, filed on Nov. 3, 2009.

(51) Int. Cl. C10G 1/04; B01D 21/00

(52) U.S. Cl. 208/390; 210/252

(57) ABSTRACT

A process for extracting bitumen from problem oil sand ores having low bitumen content and/or high fines content is provided, comprising: mixing the problem oil sand ore with heated water to produce an oil sand slurry; conditioning the oil sand slurry for a period of time sufficient to substantially disperse oil sand lumps and promote the release and coalescence of bitumen flecks from the sand grains; removing a sufficient amount of solids from the conditioned oil sand slurry in a de-sander circuit; and subjecting the solids-reduced oil sand slurry to gravity separation in a bitumen separation vessel to allow the bitumen to float to the top of the vessel to form clean bitumen froth.

This application claims the benefit of U.S. Provisional Application No. 61/257,552, filed Nov. 3, 2009.

### FIELD OF THE INVENTION

The present invention relates to a method and process line for improving bitumen recovery from problem oil sand ores such as those that have higher fines content, including ores of lower bitumen grade. More particularly, conditioned oil sand slurry prepared from problems ores is subjected to a solids reduction or de-sander circuit that reduced its solids content prior to bitumen separation in a primary separation vessel (PSV).

### BACKGROUND OF THE INVENTION

Existing water-based oil sand extraction flowsheets are practically limited to processing ores that are relatively high in bitumen content and low in fines content, and, preferably, of estuarine facies. However, there exists an abundance of “problem ores” that cannot be processed in existing extraction plants unless a high proportion of high-grade good processing ores are blended into these ore feeds. “Problem ores” refers to those oil sand ores having high fines content or low bitumen content or both. Hence, it is necessary to plan well ahead prior to the opening of a new mine to ensure that sufficient amount of good ores will be available for blending.

Ore blending criteria include limiting the fines content (<44 μm) in the ore feed and the solids d₅₀ to some specified maximum levels to prevent processability and pipeline sanding issues, thereby limiting the maximum proportion of problem ores in the blends. By way of example and without being limiting, it may be desirable to limit the fines content to a maximum of about 28-30% and the solid d₅₀ to about 250-300 μm. Thus, the proportion of problem ores in blends may be limited to about 30% in many cases.

However, blending criteria are not always possible to meet, particularly for day-to-day operations. Furthermore, ore blending activities significantly increase operation cost, energy usage and reduce production capacity. The challenge is to widen the processability window for an extraction plant to be able to handle greater types of ore feed and to reduce the required amount of good ores in the feed when ore blending is needed.

Oil sand slurry de-sanding or solids removal is known in the art and is primarily used to increase operation reliability and reduce operating costs for bitumen production. The benefits are derived from a reduction of transportation distance for the removed solids, which would enable coarse sands to be available sooner for forming composite tailings (CT), for land reclamation and to decrease wear and size requirements of the downstream equipment and piping.

However, it was surprisingly discovered by the present inventors that using a de-sander circuit of the present invention resulted in enhanced oil sand processability of problem ores and provided several options that can be implemented to the downstream equipment and process for performance and operation benefits.

### SUMMARY OF THE INVENTION

The current application of oil sand slurry solids reduction or de-sanding is focused on enhancing oil sand processability with an emphasis on enabling a bitumen extraction plant to process various types of high fines ores, low bitumen ores, or other such problem ores and blended ores containing significantly higher amount of poor ores in the feed stock, as well as normal ores at higher bitumen separation vessel feed density. It enables the modification of downstream processes and flowsheets to achieve performance and operation benefits. Oil sand slurry de-sanding can also be used to reduce the solids d₅₀ in ores that are too high in coarse solids, which may result in sanding problems in both the hydrotransport pipeline to the extraction plant and in the extraction plant tailings pipeline.

A process for extracting bitumen from problem oil sand ores having low bitumen content and/or high fines content is provided comprising:
mixing the problem oil sand ore with heated water to produce an oil sand slurry;
conditioning the oil sand slurry for a period of time sufficient to substantially disperse oil sand lumps and promote the release and coalescence of bitumen flecks from the sand grains;
removing a sufficient amount of solids from the conditioned oil sand slurry in a de-sander circuit; and
subjecting the solids-reduced oil sand slurry to gravity separation in a bitumen separation vessel to allow the bitumen to float to the top of the vessel to form clean bitumen froth.

In one embodiment, the de-sander circuit comprises a single solid/liquid separator/splitter or a plurality (two or more) of solid/liquid separators/splitters arranged in series. In one embodiment, the solid/liquid separators/splitters are selected from the group consisting of inclined settlers, cycloseparators, hydrocyclones, gravity separators, inclined plate settlers, centrifuges, desanders, desilters, shale-shakers, and the like. It is understood that when using two or more solid/liquid separators/splitters, each solid/liquid separator/splitter may be the same or different.

In one embodiment, a series of solid/liquid separators/splitters operate in a counter-current flow, each separator/splitter producing an underflow and an overflow, wherein the underflow of the first separator is fed to the next separator in series and the overflow of each separator is fed to the preceding separator, the overflow from the first separator being the de-sanded oil sand slurry that is fed to the primary separation vessel. In another embodiment, a series of two or more solid/liquid separators/splitters are used whereby the conditioned oil sand slurry is added to the last solid/liquid separator/splitter in the series and the overflow of the solid/liquid separator/splitter is fed to the solid/liquid separator/splitter immediately preceding it until the overflow of the first solid/liquid separator/splitter is fed to the bitumen separation vessel.

It is understood, however, that other de-sanding or solid removal devices or circuits can be used that can remove sufficient amount of solids and hence reduce the solids loading and the bulk density of the oil sand slurry that is fed to the bitumen froth separation vessel. Thus, as opposed to simple dilution (e.g., with more water addition), the present invention reduces the solids loading and slurry density by removing a sufficient amount of coarse solids while decreasing the slurry volume. Otherwise, the bitumen froth separation vessel would have to be enlarged to reduce solids loading and to handle the larger volume of slurry if water was to be added to provide lower density slurry.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1a is a schematic of an embodiment of the present invention showing a process line useful in processing oil sand and extracting bitumen therefrom which includes a de-sander circuit.

FIG. 1b is a cross-sectional of an inclined plate settler useful in the present invention.

FIG. 1c is a schematic of one embodiment of a de-sander circuit useful in the present invention comprising two different solid/liquid separators/splitters.

FIG. 1d is a schematic of one embodiment of a de-sander circuit useful in the present invention comprise two of the same solid/liquid separators/splitters.

FIG. 2 is a schematic of a pilot circuit of the present invention designed to assess the effectiveness of processing oil sand and extracting bitumen using a de-sander circuit.

FIG. 3 is a cross-sectional of an inclined settler useful in the present invention.

FIG. 4 is a graph showing the overall bitumen recovery in a primary separation vessel when using the process of the present invention.

### DETAILED DESCRIPTION OF THE PREFERRED EMBODIMENT

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

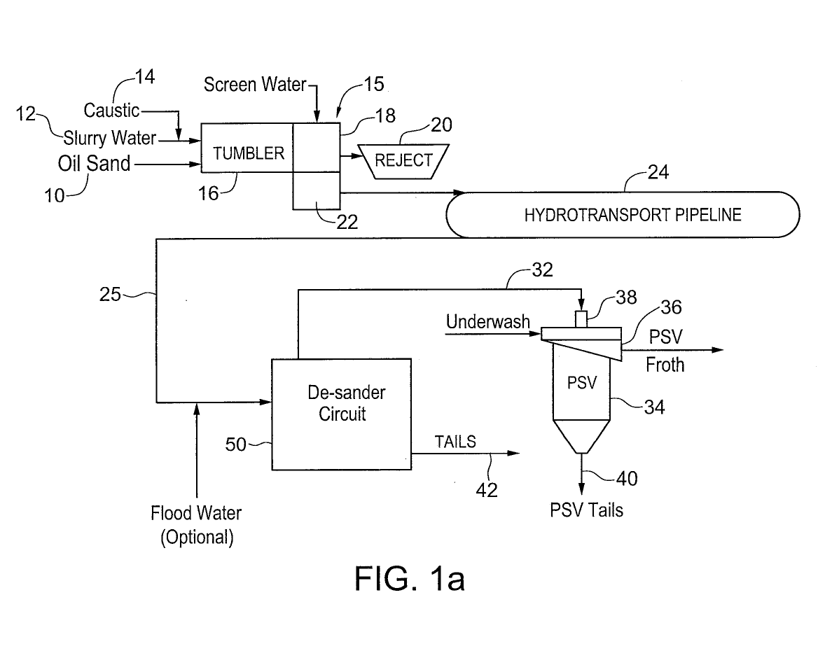

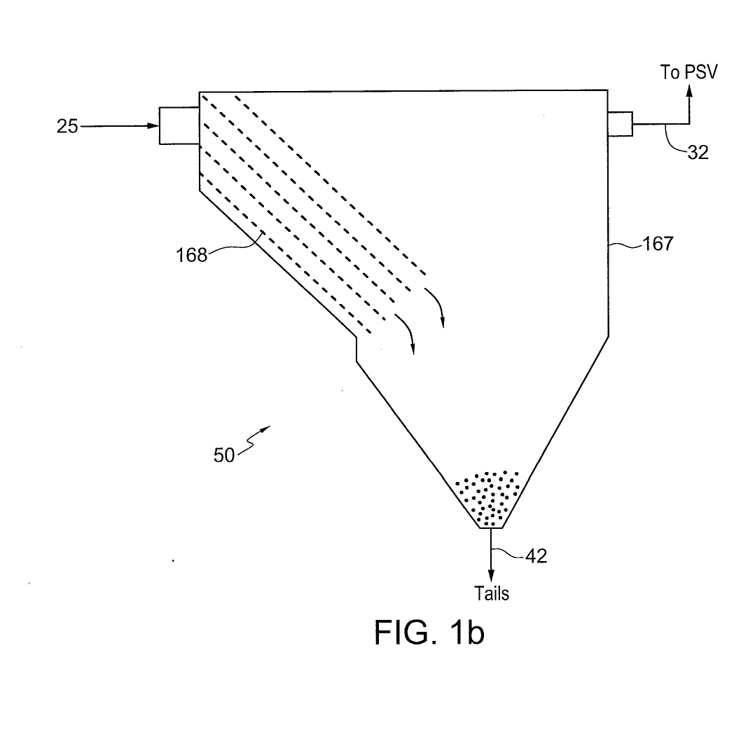

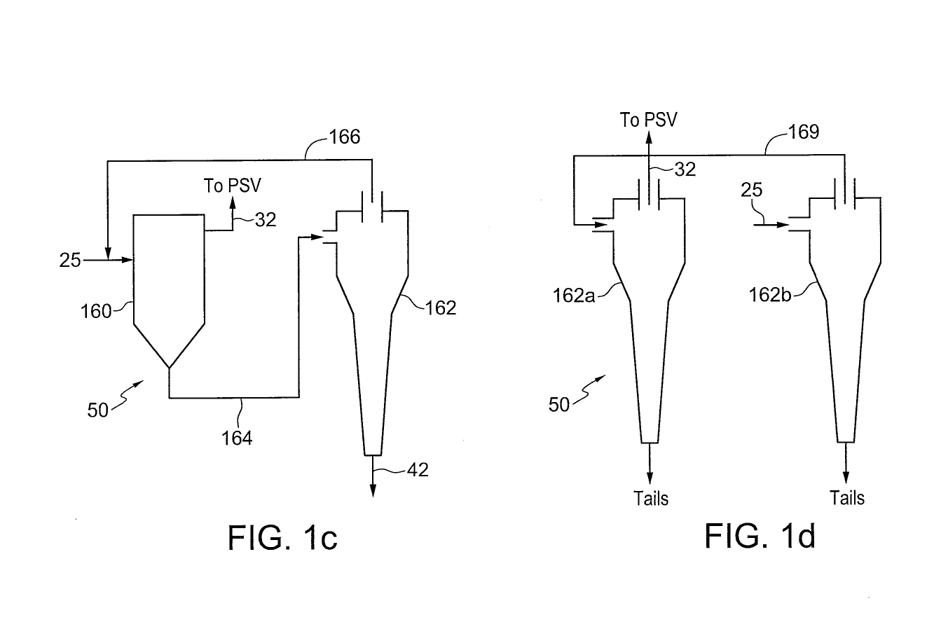

FIG. 1a is a schematic of an embodiment of the process and process line of the present invention useful in obtaining bitumen from problem oil sand ores. Oil sand 10 is mined from an oil sand rich area such as the Athabasca Region of Alberta and mixed with heated water 12 in a slurry preparation unit, which unit is shown here generally as element 15. As shown in FIG. 1, slurry preparation unit 15 may comprise tumbler 16, screening device 18 and pump box 22; however, it is understood that any slurry preparation unit known in the art can be used. In addition to the oil sand 10 and water 12, optionally, caustic 14 is also added to tumbler 16 to aid in conditioning the oil sand slurry. The oil sand slurry is then screened through screening device 18, where additional water may be added to clean the rejects (e.g., oversized rocks) prior to delivering the rejects to rejects pile 20. The screened oil sand slurry is collected in a vessel such as pump box 22 where the oil sand slurry is then pumped through a hydrotransport pipeline 24, which pipeline is of a adequate length to ensure sufficient conditioning of the oil sand slurry, e.g., thorough digestion/ablation/dispersion of the larger oil sand lumps, coalescence of released bitumen flecks and aeration of the coalesced bitumen droplets.

The conditioned oil sand slurry 25 is then de-sanded prior to further processing of the oil sand slurry which separates the bitumen droplets from the remaining solids. De-sanding occurs in a de-sander circuit 50. Examples of de-sander circuit 50 are shown in FIGS. 1b, 1c and 1d, which circuits are described in more detail below.

The bitumen rich overflow 32 from de-sander circuit 50 is then fed through feed box 38 of primary separation vessel (PSV) 34, which bitumen froth separation vessel operates under somewhat more quiescent conditions to allow the bitumen froth to rise to the top of the vessel and over flow to the launder 36 and collected as PSV bitumen froth for further treatment. PSV tails 40 are either discarded or further treated for additional bitumen recovery. Tails 42 from de-sander circuit 50 can be processed for secondary bitumen recovery or be discharged to provide coarse sands for forming composite tailings (CT) for land reclamation, depending on the bitumen recovery efficiency of the de-sander.

FIG. 1b shows one embodiment of a de-sander circuit 50 useful in the present invention which comprises only a single solid/liquid separator/splitter, namely, inclined plate settler 167. In this embodiment, conditioned oil sand slurry 25 is fed at or near the top of inclined plate settler 167 which settler comprises a plurality of inclined plates 168. The overflow is removed as bitumen rich overflow 32 and the coarser solids settle to the bottom of inclined plate settler 167 where the solids are removed from the bottom as tails 42.

FIG. 1c shows another embodiment of a de-sander circuit 50 useful in the present invention which comprises two solid/liquid separators/splitters, each of which is different. In this embodiment, the conditioned oil sand slurry 25 is first fed to gravity separator 160 where the coarser solids are allowed to settle and are removed as stream 164 from the bottom of gravity settler 160 and fed into hydrocyclone 162. The tails 42 are removed from hydrocyclone 42, where they are disposed of as described above. Overflow 166, however, is added back to gravity separator 160 where more bitumen is captured and removed as bitumen rich overflow 32. This is a simple example of counter-current flow.

FIG. 1d shows yet another embodiment of a de-sander circuit 50 useful in the present invention which comprises two similar/same solid/liquid separators/splitters. In this embodiment, de-sander circuit comprises two hydrocyclones, 162a and 162b, respectively. In this embodiment, the conditioned oil sand slurry 25 is first fed to the later hydrocyclone 162b, where the coarser solids are allowed to settle and are removed as tails from the bottom of hydrocyclone 162b. The overflow 169 is removed from hydrocyclone 162b and fed into hydrocyclone 162a. Bitumen rich overflow 32 is then removed from hydrocyclone 162 for further processing.

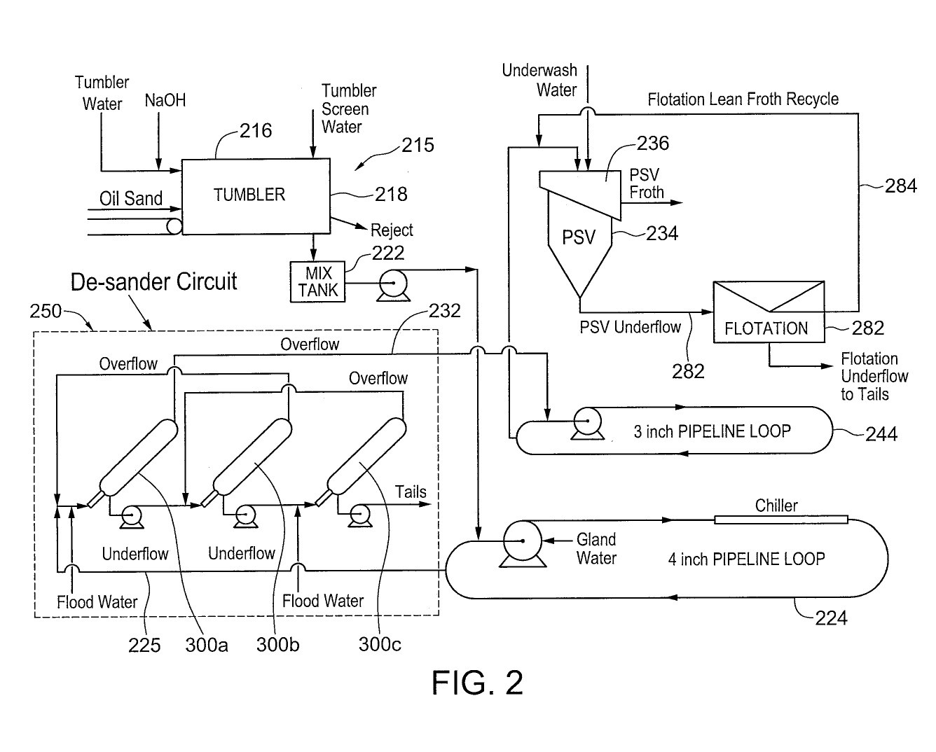

FIG. 2 shows the pilot circuit used in Example 1 below. In FIG. 2, oil sand, tumbler water and NaOH are mixed in tumbler 216, screened using screen 218 and the screened oil sand slurry is retained in mix tank 222. The oil sand slurry is then conditioned in a 4 inch pipeline loop 224 and conditioned oil sand slurry 225 is initially processed in de-sander circuit 250. In this instance, de-sander circuit 250 comprises three inclined settlers, 300a, 300b and 300c, in series. The inclined settlers 300a, 300b and 300c operate counter-currently as follows. Conditioned oil sand slurry 225 is fed to the first inclined settler 300a in the series and the underflow of inclined settler 300a is fed to the second in series inclined settler 300b. The underflow of inclined settler 300b is then fed to inclined settler 300c. The overflow of inclined settler 300b is fed back to the first inclined settler 300a in the series and the overflow of inclined settler 300c is fed back to inclined settler 300b.

The bitumen rich overflow 232 from inclined settler 300a may be further conditioned in a second hydrotransport pipeline (also referred to as a de-sanded slurry loop) 244, which is used to transport the bitumen rich overflow 232 to the primary separation vessel 234, should the PSV be located some distance away from the de-sander circuit 250. In this embodiment, the PSV underflow 282 is subjected to flotation in flotation cell 282 and the flotation lean froth 284 is recycled back to the PSV 234. The PSV froth is then analyzed.

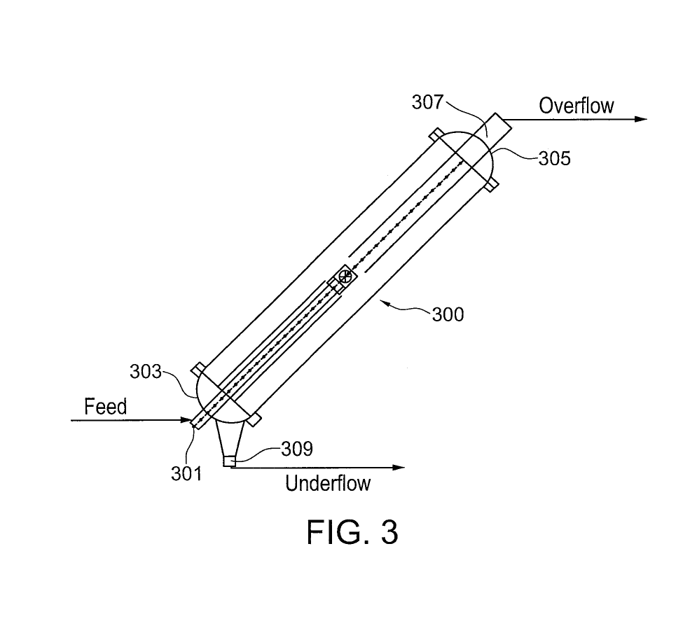

FIG. 3 shows another embodiment of a gravity settler that can be used in a de-sander circuit of the present invention and which was used in the pilot circuit. Inclined settler 300 is a generally cylindrical shaped vessel having a feed inlet 301 at or near the bottom end 303 for feeding oil sand slurry to the inclined settler 300 and an overflow outlet 307 at or near the top end 305 of the settler. Inclined settler 300 further comprises underflow outlet 309 for removing the solids that settle near the bottom end 303 of the vessel.

It was demonstrated that using a de-sander circuit resulted in high bitumen recoveries of 97 and up to 99% and solids removal typically ranging from 31-40%; however, it is understood that even higher solids removals can be achieved and might be needed for some ore feeds. The de-sanded oil sand slurry produced is significantly lower in density and solids concentration but higher in bitumen content. The combined effects of these changes to the PSV feed slurry by de-sanding was demonstrated to dramatically increase the primary bitumen recovery for ore feeds that otherwise gave poor bitumen recovery. In fact, one of the ores tested, discussed in more detail below in Example 1, was low in grade (9%) and high in fines (29%). The present invention can be used on even lower grade ore (e.g., 8.5%) with up to 40% fines or greater.

It was also demonstrated that the de-sanded slurry enabled both the PSV middlings and underflow streams to be processed in a standard mechanical flotation unit, which resulted in higher secondary and combined bitumen recoveries.

### Example 1

The bitumen extraction process of the present invention was tested in a pilot oil sand slurry de-sander circuit as shown in FIG. 2 (De-sander Case) using a low grade oil sand comprising 9.3% bitumen, 86.2% solids and 29.5% fines. In this example, the de-sander circuit comprises three (3) inclined settlers and counter-current flow was practiced. Ordinarily, the oil sand ore used in this example would have to be blended with a high-grade oil sand before processing in order to obtain acceptable bitumen recoveries. The results were then compared with those obtained for the same low-grade oil sand when it was subjected to an extraction process as shown in FIG. 2, except where the de-sander circuit was omitted (Base Case). These results are shown in Table 1 and Table 2 below.

TABLE 1

| Flowsheet | Base Case | De-Sander |
|---|---|---|
| De-Sander Circuit Combined Bitumen Recovery, | N/A | 97.0 |
| % | | |
| De-Sander Circuit Combined Solids Removal, % | N/A | 31.0 |
| PSV Overall Bitumen Recovery (Rejects-Free), % | 62.0 | 91.0 |
| PSV Froth % Bitumen | 52.0 | 54.1 |
| PSV Froth % Solids | 16 | 14.0 |

TABLE 2

| | | | PSV | | | |
|---|---|---|---|---|---|---|
| | PSV Feed | | Solids | Primary | Froth Quality | |
| | Density | Bitumen | Loading | Recovery | Bitumen | Solids |
| | g/cc | % | kg/s/m² | % | % | % |
| Base | 1.38 | 4.7 | 2.90 | 35 | 56.3 | 13.5 |
| Case | | | | | | |
| De- | 1.33 | 6.3 | 1.68 | 82 | 56.9 | 13.7 |
| Sander | | | | | | |

It can be clearly seen from the results in Tables 1 and 2 that the overall rejects-free bitumen recovery was greatly improved, i.e., increased from 62% to 91%, after processing the conditioned oil sand slurry in a de-sander circuit. While this large increase in overall bitumen recovery may be partly due to the processing of entire middlings and tailings from the PSV, without being bound to theory, it is believed that the key driver is the improvement in PSV performance. The results also show that the overall froth quality of the bitumen froth obtained from the PSV with de-sanding is essentially the same as the froth quality obtained without de-sanding. Thus, the bitumen froth recovered is of a quality necessary for further upgrading.

Thus, without being bound to theory, it is believed that the main effect of de-sanding on overall bitumen production is the improved PSV performance. In Table 2, the tests were performed where the Flotation unit was excluded. Hence, the results would show only the impact on the PSV. The de-sanding system lowered the PSV feed density from 1.38 to 1.33 g/cc and increased its bitumen content from 4.7 to 6.3%. It also reduced the PSV solids loading from 2.90 to 1.68 kg/s/m². Comparing the PSV performance, the de-sanding increased the PSV bitumen recovery from 35 to 82%, with no penalty in froth quality.

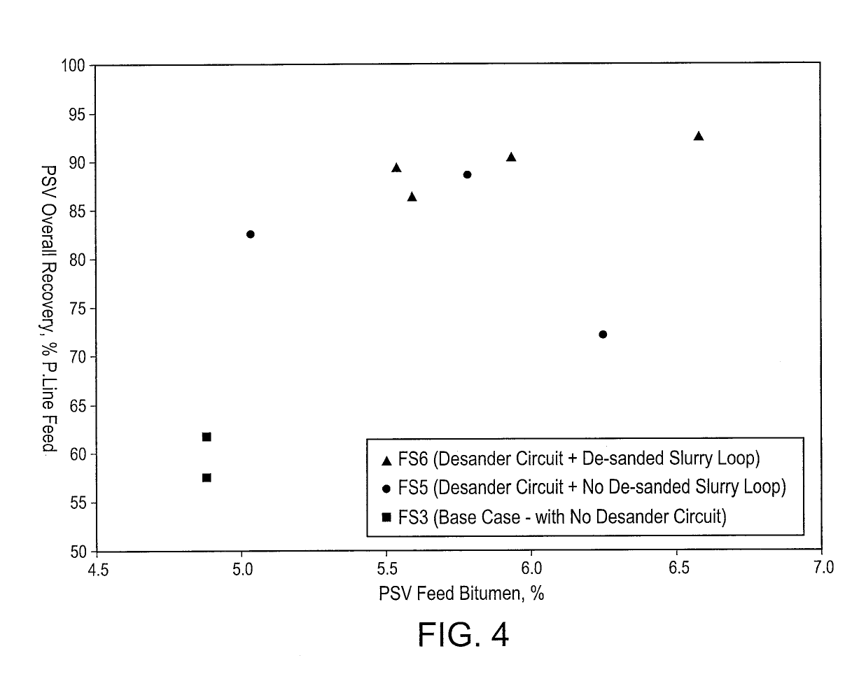

FIG. 4 is a graph showing the overall bitumen recovery from the PSV for the same low-grade ore when the de-sander circuit was used with or without a second hydrotransport pipeline or De-sander Slurry Loop. The addition of a second hydrotransport pipeline improved overall bitumen recovery in the PSV, as shown by the shaded triangles. Thus, adding a second pipeline does not adversely affect bitumen recovery and in fact improves bitumen recovery.

Without being bound to theory, in 1979, Professor Jacob Masliyah developed an extended hindered settling equation (Equation 1) that explains the bitumen slip velocity. Slip velocity is the relative velocity of bitumen (species I) to the fluid (species f) or water in the present invention,

where
μᵢ is the velocity of the particles (e.g. bitumen droplets or clay particles)
ν_{f} is the velocity of the fluid
dᵢ is the particle diameter
μ_{f} is the effective viscosity of the fluid (or suspension at high clay content)
ρᵢ is the density of the particles
ρₛᵤₛₚ is the density of the suspension
α_{f} is the volume fraction for the fluid.

It is thought that oil sand conditioning mainly improves the slip velocity by making the bitumen droplets bigger in size and lower in density. Although de-sanding may affect several factors, it is believed that it mainly reduces the hindered effects by removing coarse solids. In other words, it increases the volume fraction of water, α_{f}, which in this equation is raised to the n^{th} power. Consequently, by increasing the volume fraction of water, the bitumen droplets can more easily slip by and rise faster, without the hindrance of the settling coarse solids, thereby ultimately improving bitumen-solids separation. The power n ranges from 5 to 10, or larger, depending on the type and concentration of solids.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A process for extracting bitumen from problem oil sand ores having low bitumen content and/or high fines content, comprising:
mixing the problem oil sand ore with heated water to produce an oil sand slurry;
conditioning the oil sand slurry for a period of time sufficient to substantially disperse oil sand lumps and promote the release and coalescence of bitumen flecks from the sand grains;
removing a sufficient amount of solids from the conditioned oil sand slurry in a de-sander circuit; and
subjecting the solids-reduced oil sand slurry to gravity separation in a bitumen separation vessel to allow the bitumen to float to the top of the vessel to form clean bitumen froth.

2. The process as claimed in claim 1, wherein the desander circuit comprises at least one solid/liquid separator/splitter.

3. The process as claimed in claim 2, wherein the solid/liquid separator/splitter is an inclined separator.

4. The process as claimed in claim 2, wherein the at least one solid/liquid separator/splitter is selected from the group consisting of a cycloseparator, a hydrocyclone, a gravity separation vessel, an inclined plate settler, a centrifuge, a desander, a shale-shaker, a desilter and combinations thereof.

5. The process as claimed in claim 1, wherein the desander circuit comprises a plurality of solid/liquid separators/splitters in series.

6. The process as claimed in claim 5, each solid/liquid separator/splitter producing an underflow and an overflow, wherein the underflow of the first solid/liquid separator/splitter in series is fed to the next solid/liquid separator/splitter in series and the overflow of each subsequent solid/liquid separator/splitter is fed to the proceeding solid/liquid separator/splitter, the overflow from the first solid/liquid separator/splitter being the solids-reduced oil sand slurry that is fed to the bitumen separation vessel.

7. The process as claimed in claim 6, wherein the solid/liquid separators/splitters are inclined settlers.

8. The process as claimed in claim 6, wherein the solid/liquid separators/splitters are selected from the group consisting of cycloseparators, hydrocyclones, gravity separation vessels, inclined plate settlers, centrifuges, desanders, desilters, shale-shakers or combinations thereof.

9. A de-sander circuit comprising:
a plurality of countercurrently operating solid/liquid inclined separators arranged in series, each separator producing an underflow and an overflow, wherein the underflow of the first separator is fed to the next separator in series and the overflow of each separator is fed to the preceding separator,
whereby the overflow from the first separator is a bitumen rich, reduced solids slurry.
